(19) United States
(12) Patent Application Publication
(10) Pub. No.: US 2016/0114294 A1
(43) Pub. Date: Apr. 28, 2016

(54) Polyelectrolyte Multilayer Films for Gas Separation and Purification

(71) Applicant: THE TEXAS A&M UNIVERSITY SYSTEM, College Station, TX (US)

(72) Inventors: Jaime C. Grunlan, College Station, TX (US); Benjamin A. Wilhite, College Station, TX (US)

(73) Assignee: The Texas A&M University System, College Station, TX (US)

(21) Appl. No.: 14/896,234

(22) PCT Filed: Jun. 4, 2014
(86) PCT No.: PCT/US14/40937

§ 371 Date: Dec. 4, 2015

Related U.S. Application Data
(60) Provisional application No. 61/830,973, filed on Jun. 4, 2013.

(51) Int. Cl. B01D 67/00

(52) U.S. Cl. CPC B01D 67/0002

(57) ABSTRACT

A method includes coating a substrate to provide a separation substrate. In an embodiment, the method includes exposing the substrate to a cationic solution to produce a cationic layer deposited on the substrate. The cationic solution comprises cationic materials. The cationic materials comprise a polymer, a colloidal particle, a nanoparticle, a nitrogen-rich molecule, or any combinations thereof. The method further includes exposing the cationic layer to an anionic solution to produce an anionic layer deposited on the cationic layer to produce a layer comprising the anionic layer and the cationic layer. The anionic solution comprises a layerable material.

### BACKGROUND OF THE DISCLOSURE

1. Field of the Disclosure

This disclosure relates to the field of gas separation and more specifically to the field of gas separation by multilayer coatings.

2. Background of the Disclosure

The production of high quality gas such as hydrogen and oxygen has experienced increased importance. For instance, there has been an increased need for renewable and clean energies that use hydrogen, oxygen, and other gases. Different methods have been developed to produce (i.e., purify or separate) such gases. Methods include pressure-swing adsorption processes and cryogenic distillation processes. Drawbacks to such methods include expensive costs involved and the large amount of energy expended. Further drawbacks include complexities with their operation and inabilities to meet certain purity requirements.

Methods have been developed to overcome such drawbacks. Such further methods include polymer membranes. However, polymer membranes also have drawbacks. Such drawbacks include low selectivity. Further drawbacks include insufficient mechanical properties.

Consequently, there is a need for improved methods for separating and purifying gases and liquids. There is a further need for improved gas and liquid separation membranes.

### BRIEF SUMMARY OF SOME OF THE PREFERRED EMBODIMENTS

In an embodiment, these and other needs in the art are addressed by a method for coating a substrate to provide a separation membrane (i.e., for separating gas or liquid). The method includes exposing the substrate to a cationic solution to produce a cationic layer deposited on the substrate. The cationic solution comprises cationic materials. The cationic materials include a polymer, colloidal particles, nanoparticles, nitrogen-rich molecules, or any combinations thereof. The method also includes exposing the cationic layer to an anionic solution to produce an anionic layer deposited on the cationic layer. The deposition produces a bilayer comprising the cationic layer and the anionic layer. The anionic solution comprises layerable materials.

In embodiments, these and other needs in the art are addressed by a method for coating a substrate to provide a separation membrane (i.e., for separating gas or liquid). The method includes exposing the substrate to an anionic solution to produce an anionic layer deposited on the substrate. The anionic solution includes layerable materials. The method also includes exposing the anionic layer to a cationic solution to produce a cationic layer deposited on the anionic layer. The deposition produces a bilayer comprising the anionic layer and the cationic layer. The cationic solution includes cationic materials. The cationic materials include a polymer, colloidal particles, nanoparticles, nitrogen-rich molecules, or any combinations thereof.

The foregoing has outlined rather broadly the features and technical advantages of the present disclosure in order that the detailed description of the disclosure that follows may be better understood. Additional features and advantages of the disclosure will be described hereinafter that form the subject of the claims of the disclosure. It should be appreciated by those skilled in the art that the conception and the specific embodiments disclosed may be readily utilized as a basis for modifying or designing other embodiments for carrying out the same purposes of the present disclosure. It should also be realized by those skilled in the art that such equivalent embodiments do not depart from the spirit and scope of the disclosure as set forth in the appended claims.

### BRIEF DESCRIPTION OF THE DRAWINGS

For a detailed description of the preferred embodiments of the disclosure, reference will now be made to the accompanying drawings in which:

FIG. 1 illustrates a coated substrate embodiment;

FIG. 2 illustrates an embodiment with bilayers of layerable materials and additives;

FIG. 3 illustrates an embodiment with alternating layers of layerable materials and additives;

FIG. 4 illustrates an embodiment with bilayers of layerable materials and additives;

FIG. 5 illustrates an embodiment of a coating with a quadlayer and a primer layer;

FIG. 6 illustrates an embodiment of an all polymer assembly;

FIG. 7(a) illustrates elastic modulus;

FIG. 7(b) illustrates hardness;

FIG. 7(c) illustrates absorbance;

FIG. 8 illustrates selectivity and permeability;

FIG. 9 illustrates oxygen transmission rate;

FIG. 10(a) illustrates upper bound selectivity limits;

FIG. 10(b) illustrates upper bound selectivity limits;

FIG. 11(a) illustrates TEM cross-sectional images of (PEI/GO) on PS using 0.01 wt. % GO deposition suspensions; and

FIG. 11(b) illustrates TEM cross-sectional images of (PEI/GO) on PS using 0.05 wt. % GO deposition suspensions.

### DETAILED DESCRIPTION OF THE PREFERRED EMBODIMENTS

In an embodiment, a multilayer thin film coating method provides a substrate with a separation film by alternately depositing positive (or neutral) and negative (or neutral) charged layers on the substrate. Each pair of positive and negative layers comprises a layer. In some embodiments, at least one layer is a neutral layer. It is to be understood that a neutral layer refers to a layer that does not have a charge. In embodiments, the multilayer thin film coating method produces any number of desired layers on substrates such as bilayers, trilayers, quadlayers, pentalayers, and the like.

It is to be understood that the separation film may be a gas separation film and/or a liquid separation film. The gas to be separated may be any desirable gas. Without limitation, examples of gases include hydrogen, oxygen, helium, carbon dioxide, carbon monoxide, nitrogen, water, methane, any other gases, or any combinations thereof. Without limitation, the ability to produce high performance membranes from water-based solutions of polymers and/or nanoparticles may offer tremendous cost savings and efficiency over conventional membranes. In embodiments, the separation film (i.e., membrane) may be used as a liquid purification/separation membrane for liquid separations (e.g., water/alcohol (e.g., ethanol, methanol, and the like)). It is to be understood that the substrate with the separation film, in embodiments, does not swell (i.e., with water).

The layers may have any desired thickness. In embodiments, each layer is between about 10 nanometers and about 2 micrometers thick, alternatively between about 10 nanometers and about 500 nanometers thick, and alternatively between about 50 nanometers and about 500 nanometers thick, and further alternatively between about 1 nanometers and about 100 nanometers thick.

Any desirable substrate may be coated with the multilayer thin film coating method to provide the separation film. In embodiments, the substrate is any separation material suitable for separating gas and/or liquid. In some embodiments, the substrate is a porous mechanical support. Without limitation, the substrate may mechanically reinforce the film. In embodiments, the substrate is polysulfonate, polysulfonamide, sericin, polyvinyl alcohol, polyacrylonitrile, polyacrylamide, polyvinyl alcohol, polyether sulphone, polyhdrazide, bacterial cellulose, polyamidesulfonamide, polyacrylonitrile-co-vinyl pyridine, polybenzoxazole, polyethyleneimine/polyvinylsulfate, polyallylammonium/polyvinylsulfate, polyallylammonium/dextrane sulfate, polyethyleneimine/polystyrenesulfonate sodium salt, polyallylammonium/polystyrenesulfonate sodium salt, chitosan/polystyrenesulfonate sodium salt, poly(4-vinylpridine)/polystyrenesulfonate sodium salt, poly(diallyldimethylammonium chloride)/polystyrenesulfonate sodium salt, poly[1-(trimethylsilyl)-1-propyne], porous metal (i.e., stainless steel), porous silica, porous zirconia, porous ceramics, or any combinations thereof. In an embodiment, the substrate is a porous organic material, inorganic material, polymeric material, or any combinations thereof. Further, without limitation, examples of substrates include porous metal (i.e., stainless steel), porous silica, porous zirconia, porous ceramics, or any combinations thereof. In some embodiments, the substrate is removable (i.e., free standing). In embodiments, the substrate is an alumina-coated, porous stainless steel tube.

The negative charged (anionic) layers comprise layerable materials. The layerable materials include anionic polymers, colloidal particles, phosphated molecules, sulfated molecules, boronic acid, boron containing acids, or any combinations thereof. Without limitation, examples of suitable anionic polymers include branched polystyrene sulfonate (PSS), polymethacrylic acid (PMAA), polyacrylic acid (PAA), polymers with hydrogen bonding, polyethylenimine, poly(acrylic acid, sodium salt), polyanetholesulfonic acid sodium salt, poly(vinylsulfonic acid, sodium salt), or any combinations thereof. In addition, without limitation, colloidal particles include organic and/or inorganic materials. Further, without limitation, examples of colloidal particles include clays, colloidal silica, inorganic hydroxides, silicon based polymers, polyoligomeric silsesquioxane, carbon nanotubes, graphene, or any combinations thereof. Any type of clay suitable for use in an anionic solution may be used. Without limitation, examples of suitable clays include sodium montmorillonite, hectorite, saponite, Wyoming bentonite, halloysite, vermiculite, or any combinations thereof. In an embodiment, the clay is sodium montmorillonite. In some embodiments, the clay is vermiculite. Any inorganic hydroxide that may provide gas separation may be used. In an embodiment, the inorganic hydroxide includes aluminum hydroxide, magnesium hydroxide, or any combinations thereof. Phosphated molecules refer to molecules with a phosphate ion. Examples of suitable phosphate molecules include polysodium phosphate, ammonium phosphate, ammonium polyphosphate, sodium hexametaphosphate, polyethylene glycol sulfate, poly vinyl sulfonic acid, or any combinations thereof. Sulfated molecules refer to molecules with a sulfate ion. Examples of suitable sulfated molecules include ammonium sulfate, sodium sulfate, or any combinations thereof. Any boronic acid suitable for use in an anionic layer may be used. In an embodiment, the boronic acid is 2-methylpropylboronic acid, 2-hydroxy-3-methylphenyl boronic acid, polymer-bound boronic acid, or any combinations thereof. Any boron containing acid suitable for use in an anionic layer may be used. In an embodiment, the boron containing acid is boric acid. In embodiments, any salt suitable for use in an anionic layer may be used. In embodiments, anionic materials may include a phosphate-rich salt, a sulfate-rich salt, or any combinations thereof. In alternative embodiments, one or more layers of layerable materials are neutral.

The positive charge (cationic) layers comprise cationic materials. In some embodiments, one or more cationic layers are neutral. The cationic materials comprise polymers, colloidal particles, nanoparticles, nitrogen-rich molecules, or any combinations thereof. The polymers include cationic polymers, polymers with hydrogen bonding, or any combinations thereof. Without limitation, examples of suitable cationic polymers include branched polyethylenimine (BPEI), polyethylenimine, cationic polyacrylamide, cationic poly diallyldimethylammonium chloride (PDDA), poly (melamine-co-formaldehyde), polymelamine, copolymers of polymelamine, polyvinylpyridine, copolymers of polyvinylpyridine, poly(allyl amine), poly(allyl amine) hydrochloride, poly(vinyl amine), poly(acrylamide-co-diallyldimethylammonium chloride), or any combinations thereof. Without limitation, examples of suitable polymers with hydrogen bonding include polyethylene oxide, polyallylamine, polyglycidol, polypropylene oxide, poly(vinyl methyl ether), polyvinyl alcohol, polyvinylpyrrolidone, branched polyethylenimine, linear polyethylenimine, poly(acrylic acid), poly(methacrylic acid), copolymers thereof, or any combinations thereof. In an embodiment, a cationic material comprises polyethylene oxide, polyglycidol, or any combinations thereof. In embodiments, the cationic material is polyglycidol.

In some embodiments, the polymers with hydrogen bonding are neutral polymers. In addition, without limitation, colloidal particles include organic and/or inorganic materials. Further, without limitation, examples of colloidal particles include clays, layered double hydroxides (LDH), inorganic hydroxides, silicon based polymers, polyoligomeric silsesquioxane, carbon nanotubes, graphene, or any combinations thereof. Without limitation, examples of suitable layered double hydroxides include hydrotalcite, magnesium LDH, aluminum LDH, or any combinations thereof. Without limitation, an example of a nitrogen-rich molecule is melamine. In embodiments, cationic materials may include a phosphate-rich salt, a sulfate-rich salt, or any combinations thereof. In alternative embodiments, cationic materials are neutral.

In embodiments, the positive and negative layers are deposited on the substrate by any suitable method. Embodiments include depositing the positive (or neutral) and negative (ore neutral) layers on the substrate by any liquid deposition method. Without limitation, examples of suitable methods include bath coating, spray coating, slot coating, spin coating, curtain coating, gravure coating, reverse roll coating, knife roll over (i.e., gap) coating), metering (Meyer) rod coating, air knife coating, or any combinations thereof. Bath coating includes immersion or dip. In an embodiment, the positive and negative layers are deposited by bath or spray.

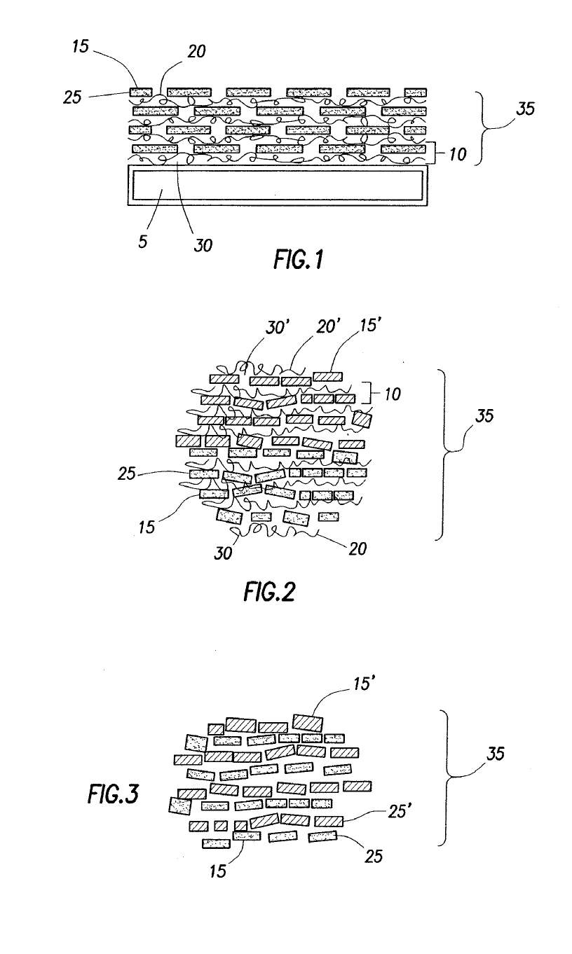

FIG. 1 illustrates an embodiment of a substrate 5 with a separation film 35 of multiple bilayers 10. In an embodiment to produce the separation film 35 coated substrate 5 shown in FIG. 1, the multilayer thin film coating method includes exposing substrate 5 to cationic molecules in a cationic mixture to produce cationic layer 30 on substrate 5. The cationic mixture contains cationic materials 20. In such an embodiment, the substrate 5 is negatively charged or neutral. The cationic mixture includes an aqueous solution of the cationic materials 20. The aqueous solution may be prepared by any suitable method. In embodiments, the aqueous solution includes the cationic materials 20 and water. In other embodiments, cationic materials 20 may be dissolved in a mixed solvent, in which one of the solvents is water, and the other solvent is miscible with water (e.g., water, methanol, ethanol, and the like). The solution may also contain colloidal particles in combination with polymers or alone, if positively charged. Any suitable water may be used. In embodiments, the water is deionized water. In some embodiments, the aqueous solution may include from about 0.05 wt. % cationic materials 20 to about 1.50 wt. % cationic materials 20, alternatively from about 0.01 wt. % cationic materials 20 to about 1.00 wt. % cationic materials 20, and alternatively from about 0.1 wt. % cationic materials 20 to about 1.0 wt. % cationic materials 20, further alternatively from about 0.1 wt. % cationic materials 20 to about 2.0 wt. % cationic materials 20, and alternatively from about 0.01 wt. % cationic materials 20 to about 10.0 wt. % cationic materials 20. In embodiments, the substrate 5 may be exposed to the cationic mixture for any suitable period of time to produce the cationic layer 30. In embodiments, the substrate 5 is exposed to the cationic mixture from about 1 second to about 20 minutes, alternatively from about 1 second to about 200 seconds, and alternatively from about 10 seconds to about 200 seconds, further alternatively from about 1 second to about 200 seconds, and also alternatively from about instantaneous to about 1,200 seconds, and further alternatively from about 1 second to about 5 seconds, and also alternatively from about 4 seconds to about 6 seconds, and additionally alternatively at about 5 seconds. Without being limited by theory, the exposure time of substrate 5 to the cationic mixture and the concentration of cationic materials 20 in the cationic mixture affect the thickness of the cationic layer 30. For instance, the higher the concentration of the cationic materials 20 and the longer the exposure time, the thicker the cationic layer 30 produced by the multilayer thin film coating method.

In embodiments, after formation of cationic layer 30, the multilayer thin film coating method includes removing substrate 5 with the produced cationic layer 30 from the cationic mixture and then exposing substrate 5 with cationic layer 30 to anionic molecules in an anionic mixture to produce anionic layer 25 on cationic layer 30 and thereby form bilayer 10. The anionic mixture contains the layerable materials 15. Without being limited by theory, the positive cationic layer 30 attracts the anionic molecules to form the cationic-anionic pair of bilayer 10. The anionic mixture includes an aqueous solution of the layerable materials 15. The aqueous solution may be prepared by any suitable method. In embodiments, the aqueous solution includes the layerable materials 15 and water. Layerable materials 15 may also be dissolved in a mixed solvent, in which one of the solvents is water and the other solvent is miscible with water (e.g., water, ethanol, methanol, and the like). Combinations of anionic polymers and colloidal particles may be present in the aqueous solution. Any suitable water may be used. In embodiments, the water is deionized water. In some embodiments, the aqueous solution may include from about 0.05 wt. % layerable materials 15 to about 1.50 wt. % layerable materials 15, alternatively from about 0.01 wt. % layerable materials 15 to about 1.00 wt. % layerable materials 15, and alternatively from about 0.1 wt. % layerable materials 15 to about 1.0 wt. % layerable materials 15, further alternatively from about 0.1 wt. % layerable materials 15 to about 2.0 wt. % layerable materials 15, and alternatively from about 0.01 wt. % layerable materials 15 to about 10.0 wt. % layerable materials 15. In embodiments, substrate 5 with cationic layer 30 may be exposed to the anionic mixture for any suitable period of time to produce anionic layer 25. In embodiments, substrate 5 with cationic layer 30 is exposed to the anionic mixture from about 1 second to about 20 minutes, alternatively from about 1 second to about 200 seconds, and alternatively from about 10 seconds to about 200 seconds, further alternatively from about instantaneous to about 1,200 seconds, and also alternatively from about 1 second to about 5 seconds, further alternatively from about 4 seconds to about 6 seconds, and additionally alternatively about 5 seconds. Without being limited by theory, the exposure time of substrate 5 with cationic layer 30 to the anionic mixture and the concentration of layerable materials 15 in the anionic mixture affect the thickness of anionic layer 25. For instance, the higher the concentration of the layerable materials 15 and the longer the exposure time, the thicker the anionic layer 25 produced by the multilayer thin film coating method. Substrate 5 with bilayer 10 is then removed from the anionic mixture. In embodiments, the exposure steps are repeated with substrate 5 having bilayer 10 continuously exposed to the cationic mixture and then the anionic mixture to produce multiple bilayers 10 as shown in FIG. 1. The repeated exposure to the cationic mixture and then the anionic mixture may continue until the desired number of bilayers 10 is produced. It is to be understood that the same method is used to produce trilayers, quadlayers, and the like.

In an embodiment as shown in FIG. 5, separation film 35 has quadlayer 100 having cationic layer 30 with anionic layer 25 on cationic layer 30, a second cationic layer 30″ on anionic layer 25, and a second anionic layer 25″ on second cationic layer 30″. As shown, quadlayer 100 has anionic layer 25 having layerable materials 15, anionic layer 25″ having layerable materials 15″, cationic layer 30 having cationic materials 20, and cationic layer 30″ having cationic materials 20″. In embodiments as shown in FIG. 5, separation film 35 also comprises primer layer 105. Primer layer 105 is disposed between substrate 5 and cationic layer 30 of quadlayer 100. Primer layer 105 may have any number of layers. The layer of primer layer 105 proximate to substrate 5 has a charge with an attraction to substrate 5, and the layer of primer layer 105 proximate to cationic layer 30 has a charge with an attraction to cationic layer 30. In embodiments as shown in FIG. 5, primer layer 105 is a bilayer having a first primer layer 110 and a second primer layer 115. In such embodiments, first primer layer 110 is a cationic layer (or alternatively neutral) comprising first primer layer materials 120, and second primer layer 115 is an anionic layer comprising second primer layer materials 125. First primer layer materials 120 comprise cationic materials. In an embodiment, first primer layer materials 120 comprise polyethylenimine. Second primer layer materials 125 comprise layerable materials. In an embodiment, second primer layer materials 125 comprise polyacrylic acid. In other embodiments (not shown), primer layer 105 has more than one bilayer. In alternative embodiments, primer layer 105 may have bilayers, trilayers, quadlayers, higher numbers of layers, or any combinations thereof.

It is to be understood that the multilayer thin film coating method is not limited to exposure to a cationic mixture followed by an anionic mixture. In embodiments in which substrate 5 is positively charged, the multilayer thin film coating method includes exposing substrate 5 to the anionic mixture followed by exposure to the cationic mixture. In such embodiment (not illustrated), anionic layer 25 is deposited on substrate 5 with cationic layer 30 deposited on anionic layer 25 to produce bilayer 10 with the steps repeated until separation film 35 has the desired thickness. In embodiments in which substrate 5 has a neutral charge, the multilayer thin film coating method may include beginning with exposure to the cationic mixture followed by exposure to the anionic mixture or may include beginning with exposure to the anionic mixture followed by exposure to the cationic mixture.

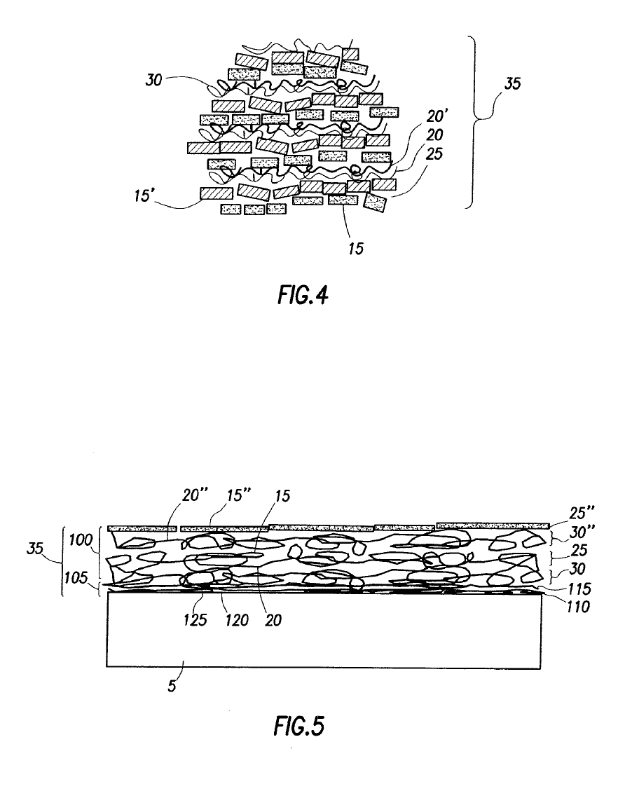

It is to be further understood that separation film 35 is not limited to one layerable material 15 but may include more than one layerable material 15 and/or more than one cationic material 20. The different layerable materials 15 may be disposed on the same anionic layer 25, alternating anionic layers 25, or in layers of bilayers 10, layers of quadlayers 100, layers of trilayers, and the like. The different cationic materials 20 may be dispersed on the same cationic layer 30 or in alternating cationic layers 30. For instance, in embodiments as illustrated in FIGS. 2-4, separation film 35 includes two types of layerable materials 15, 15′ (i.e., sodium montmorillonite is layerable material 15 and aluminum hydroxide is layerable material 15′). It is to be understood that substrate 5 is not shown for illustrative purposes only in FIGS. 2-4. FIG. 2 illustrates an embodiment in which layerable materials 15, 15′ are in different layers of bilayers 10. For instance, as shown in FIG. 2, layerable materials 15′ are deposited in the top bilayers 10 after layerable materials 15 are deposited on substrate 5 (not illustrated). FIG. 3 illustrates an embodiment in which separation film 35 has layerable materials 15, 15′ in alternating bilayers. It is to be understood that cationic materials 20 are not shown for illustrative purposes only in FIG. 3. FIG. 4 illustrates an embodiment in which there are two types of bilayers 10, comprised of particles (layerable materials 15, 15′) and cationic materials 20, 20′ (e.g., polymers).

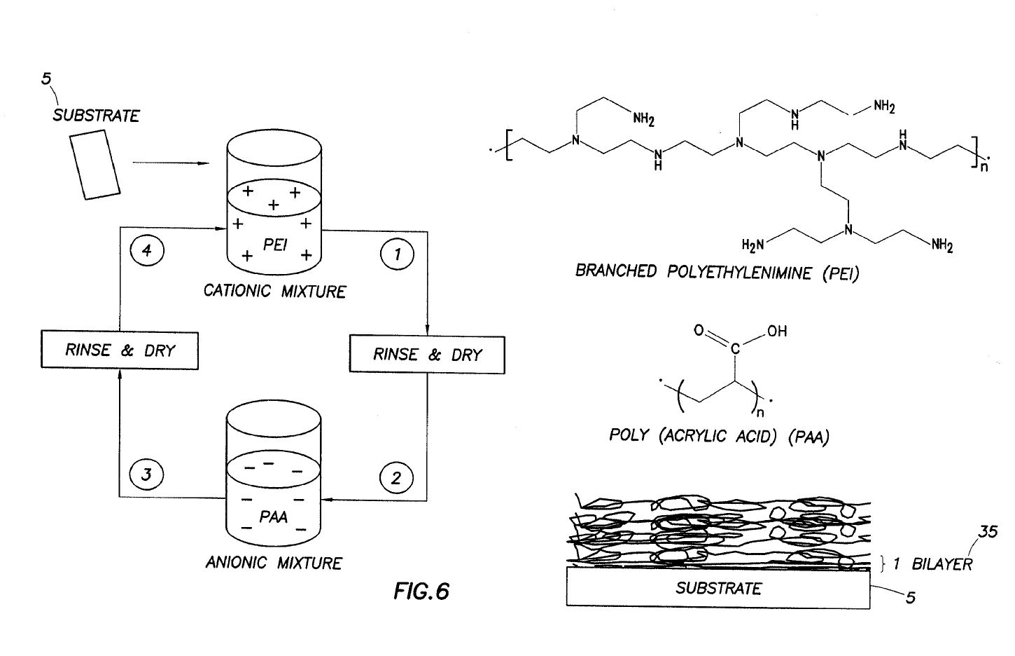

In some embodiments, the multilayer thin film coating method includes rinsing substrate 5 between each exposure step (i.e., step of exposing to cationic mixture or step of exposing to anionic mixture). FIG. 6 illustrates rinsing and drying to provide a substrate with a bilayer 35 of PEI and PAA. For instance, after substrate 5 is removed from exposure to the cationic mixture, substrate 5 with cationic layer 30 is rinsed and then exposed to an anionic mixture. After exposure to the anionic mixture, substrate 5 with bilayer 10, trilayer, quadlayer 100 or the like is rinsed before exposure to the same or another cationic mixture. The rinsing is accomplished by any rinsing liquid suitable for removing all or a portion of ionic liquid from substrate 5 and any layer. In embodiments, the rinsing liquid includes deionized water, methanol, or any combinations thereof. In an embodiment, the rinsing liquid is deionized water. Substrate 5 may be rinsed for any suitable period of time to remove all or a portion of the ionic liquid. In an embodiment, substrate 5 is rinsed for a period of time from about 5 seconds to about 5 minutes. In some embodiments, substrate 5 is rinsed after a portion of the exposure steps.

In embodiments, the multilayer thin film coating method includes drying substrate 5 between each exposure step (i.e., step of exposing to cationic mixture or step of exposing to anionic mixture). For instance, after substrate 5 is removed from exposure to the cationic mixture, substrate 5 with cationic layer 30 is dried and then exposed to an anionic mixture. After exposure to the anionic mixture, substrate 5 with bilayer 10, trilayer, quadlayer 100, or the like is dried before exposure to the same or another cationic mixture. The drying is accomplished by applying a drying gas to substrate 5. The drying gas may include any gas suitable for removing all or a portion of liquid from substrate 5. In embodiments, the drying gas includes air, nitrogen, or any combinations thereof. In an embodiment, the drying gas is air. In some embodiments, the air is filtered air. Substrate 5 may be dried for any suitable period of time to remove all or a portion of the liquid. In an embodiment, substrate 5 is dried for a period of time from about 5 seconds to about 500 seconds. In an embodiment in which substrate 5 is rinsed after an exposure step, substrate 5 is dried after rinsing and before exposure to the next exposure step. In alternative embodiments, drying includes applying a heat source to substrate 5. For instance, in an embodiment, substrate 5 is disposed in an oven for a time sufficient to remove all or a portion of the liquid. In some embodiments, drying is not performed until all layers have been deposited, as a final step before use.

In some embodiments (not illustrated), additives may be added to substrate 5 in separation film 35. The thin film coating method includes mixing the additives with layerable materials in the aqueous solution, mixing the additives with the cationic materials in the aqueous solution, or any combinations thereof. In some embodiments, separation film 35 has a layer or layers of additives. In embodiments, any additives suitable for selectivity, mechanical strength, and the like may be used. In embodiments, examples of suitable additives for selectivity and/or mechanical strength include crosslinkers. In embodiment, the multilayer thin film coating method includes the crosslinkers being added as a reduction step. Crosslinkers may be any chemical that reacts with any matter in separation film 35. Examples of crosslinkers include bromoalkanes, aldehydes, carbodiimides, amine active esters, epoxides, uridine, diols (i.e., butene diol), epichlorohydrin, aziridine, or any combinations thereof. In embodiments, the aldehydes include glutaraldehyde, di-aldehyde, or any combinations thereof. In some embodiments, the aldehydes are glutaraldehyde. In an embodiment, the carbodiimide is 1-ethyl-3-(3-dimethylaminopropyl) carbodiimide (EDC). Embodiments include the amine reactive esters including N-hydroxysuccinimide esters, imidoesters, or any combinations thereof. The crosslinkers may be used to crosslink the anionic layers 25 and/or cationic layers 30 (to one another or to themselves). In an embodiment, substrate 5 with layers (i.e., bilayer 10, trilayer, quadlayer 100, or the like) is exposed to additives in an anionic mixture in the last exposure step (i.e., separate bath, separate spray, or the like) from the exposure that provided separation film 35. In alternative embodiments, the additives may be added in an exposure step. Without limitation, crosslinking provides washability and durability to separation film 35. In an embodiment, the multilayer thin film coating method includes a second reduction step. The second reduction step may include adding any suitable reducing agent to substrate 5. In embodiments, the reducing agent includes citric acid, ascorbic acid, sodium borohydride, or any combinations thereof. In an embodiment, the multilayer thin film coating method includes soaking substrate 5 in a 0.1 M sodium borohydride solution.

In some embodiments, the pH of anionic and/or cationic solution is adjusted. Without being limited by theory, reducing the pH of the cationic solution reduces growth of separation film 35. Further, without being limited by theory, the separation film 35 growth may be reduced because the cationic solution may have a high charge density at lowered pH values, which may cause the polymer backbone to repel itself into a flattened state. In some embodiments, the pH is increased to increase the separation film 35 growth and produce a thicker separation film 35. Without being limited by theory, a lower charge density in the cationic mixture provides an increased coiled polymer. The pH may be adjusted by any suitable means such as by adding an acid or base. In an embodiment, the pH of an anionic solution is between about 0 and about 14, alternatively between about 1 and about 7, and alternatively between about 1 and about 3, and further alternatively about 3. Embodiments include the pH of a cationic solution that is between about 0 and about 14, alternatively between about 3 and about 12, and alternatively about 3.

The exposure steps in the anionic and cationic mixtures may occur at any suitable temperature. In an embodiment, the exposure steps occur at ambient temperatures. In some embodiments, the separation film is optically transparent.

The layers may be in any desired configuration such as a trilayer disposed on a bilayer 10, a quadlayer 100 disposed on a trilayer that is disposed on a bilayer 10, and the like. In addition, in some embodiments, layerable materials 15 and/or cationic materials 20 in a layer (i.e., a bilayer 10) are different than layerable materials 15 and/or cationic materials 20 in a proximate layer (i.e., a quadlayer 100). Without being limited by theory, separation films 35 that have a layer with different layerable materials 15 and/or cationic materials 20 than a proximate layer may have a synergistic effect. Such synergistic effect may increase the selectivity of separation film 35. For instance, in embodiments, a cationic layer 30 has layers that do not include clay but in one layer or other layers, clay is used as the cationic material 20.

In embodiments, an ionically crosslinked polymer film is formed using layer-by-layer assembly of a branched polyethylenimine and polyacrylic acid. The film is capable of combining exceptionally high hydrogen selectivity with remarkable mechanical properties at gas permeabilities in excess of the traditional “upper bound” associated with homogeneous polymeric membranes. This excellent hydrogen selectivity represents a significant breakthrough in the realization of low-cost, highly manufacturable polymer membranes for hydrogen purification. In an embodiment, the substrate 5 with separation film 35 (i.e., ionically crosslinked assembly) has a selectivity (gas or liquid) from about 20,000:1 to about 2:1, alternatively from about 10,000:1 to about 10:1, and alternatively from about 1,000:1 to about 100:1. In specific embodiments, this substrate 5 with separation film 35 exhibits hydrogen/nitrogen and hydrogen/carbon dioxide selectivities in excess of 1,000:1 and 100:1, respectively, which are superior to reported properties of any organic, inorganic or mixed-matrix membrane. Exceptional hydrogen permselectivities correspond to hydrogen permeabilities of about 5 barrer, which may exceed values expected from Robeson's “upper bound” relationship between permselectivity and permeability in homogeneous polymer membranes. This compact, homogeneous structure achieved through ionic crosslinking within the polyethylenimine-polyacrylic acid polyelectrolyte multilayer film displays equally outstanding mechanical properties. Modulus of this substrate 5 with separation film 35 may be from about 1 GPa to about 200 GPa, alternatively from about 1 GPa to about 100 GPa, and alternatively from about 1 GPa to about 50 GPa, further alternatively from about 10 GPa to about 50 GPa (using nanoindentation), and hardness in some embodiments is from about 0.01 GPa to about 10 GPa, alternatively from about 0.1 GPa to about 10 GPa, and alternatively from about 0.1 GPa to about 1.0 GPa. In embodiments, similar selectivities may be found between helium and carbon dioxide gases with clay-polymer assemblies, making this a relatively universal technology that may be used to purify a variety of gases that may be separated based upon size. In some embodiments, these separation films 35 may be engineered to exhibit a specified selectivity for a specified combination of gases.

As a commercial product, the substrate 5 with separation film 35 may be a gas purification membrane that provides a basis for manufacturing low-cost, robust hydrogen purification membranes. This product may be of value to the petrochemical industry, which may desire low-cost hydrogen purification. It also may be of value to energy industries desiring high-purity hydrogen at low costs.

Without limitation, no polymeric membrane exhibits the level of gas separating ability of the layer-by-layer assemblies of the separation film 35 (i.e., membrane). In embodiments, a sufficient combination of polyelectrolytes and/or nanoparticles may achieve high selectivity.

In embodiments, the layer-by-layer deposition technique further includes alumina surface treatments that may allow the separation film 35 to be applied to a broad range of industrial membrane supports. Thus, in embodiments, the separation films 35 (i.e., gas separation membrane) may be practiced by application to existing membrane support technology to produce a competitive product for meeting industry purification needs.

To further illustrate various illustrative embodiments of the present disclosure, the following examples are provided.

### Example 1

### Substrates

Porous stainless steel (PSS) tubes (0.5 μm grade, OD: 0.5″, porous length: 2″, Mott Corporation) were used as supports for a PEI/PAA assembly. PSS supports were pretreated by immersion in an alkaline solution (sodium hydroxide, organic detergent, DI water) at 60° C. for 1 hour, followed by rinsing thoroughly with DI water and then drying at 120° C. for 2 hours. The pretreated PSS tubes were coated with nanopowder alumina (Sigma-Aldrich) by a vacuum pump, which was connected to one end of the tube immersed in a nanopowder alumina solution (nanopowder alumina:alumina sol (˜20%, Alfa-Aser), DI water (wt. % ratio: 1:7:0.1)), and the other end of the tube was plugged with a rubber stopper. After being annealed at 450° C. for 4 hours with a heating and cooling rate of 3° C./min, the PSS tubes were airbrushed with alumina gel (dissolved alumina in nitric acid (Mallinckrodt Baker), followed by pH titration to near-neutral using ammonium hydroxide (Mallinckrodt Baker)) and annealed at the same condition described above.

Materials:

Branched polyethylenimine (Aldrich, St. Louis, Mo.) (MW 25,000 g mol−1) was dissolved into deionized water (18.2 MΩ) for making solution (0.1 wt. %). The pH was adjusted from its unaltered value (˜10.5) to 10 by adding hydrochloric acid (HCl) (1.0 M). Poly(acrylic acid) (Aldrich) (MW˜100,000 g mol⁻¹) solution (0.2 wt. %) was prepared with deionized water (18.2 MΩ). The pH of PAA was adjusted from its unaltered value (˜3.1) to 4 by adding NaOH (1.0 MΩ).

LbL Deposition:

The alumina-coated PSS tube was first dipped into the polycation solution (PEI) for 5 minutes, followed by rinsing with deionized water for 30 seconds and drying with a stream of filtered air. After the first positively-charged layer was adsorbed, the substrate was dipped into PAA solution for another 5 minutes, followed by another rinsing and drying cycle. One deposition cycle was defined as one bilayer. Starting from the second deposition cycle, the remaining numbers of layers were created using one minute dip times. This process was carried out using home-built robot systems.

Characterization:

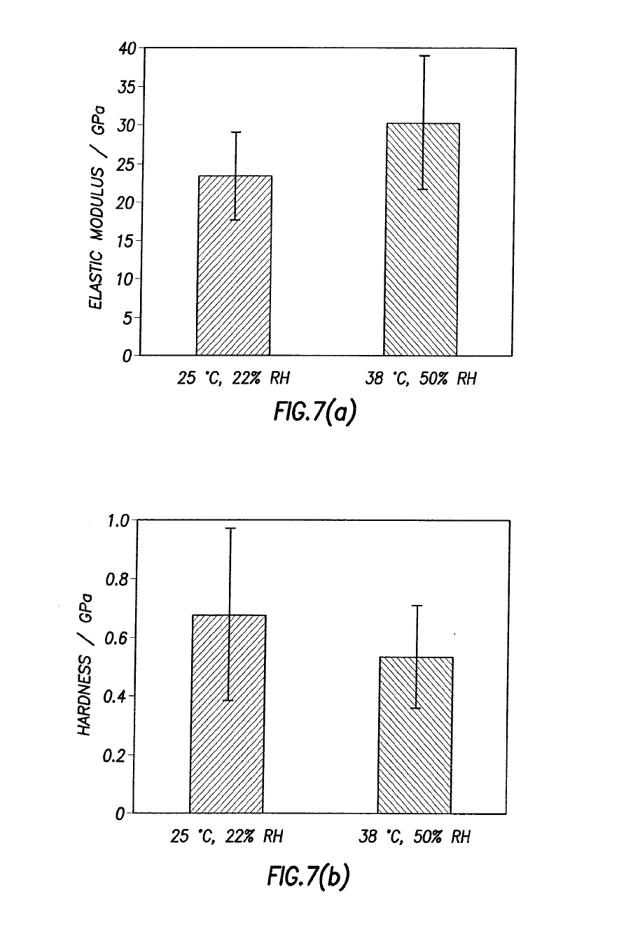

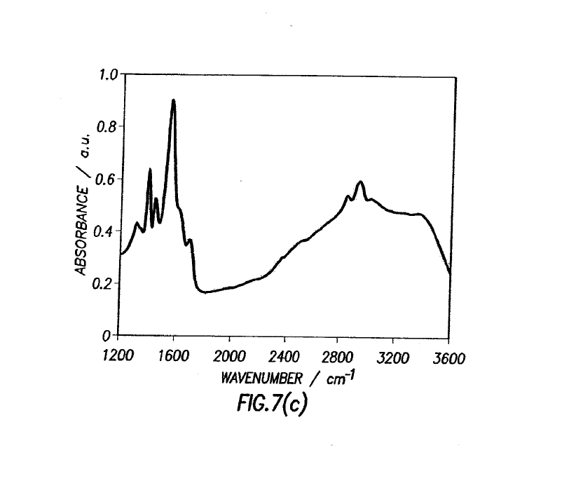

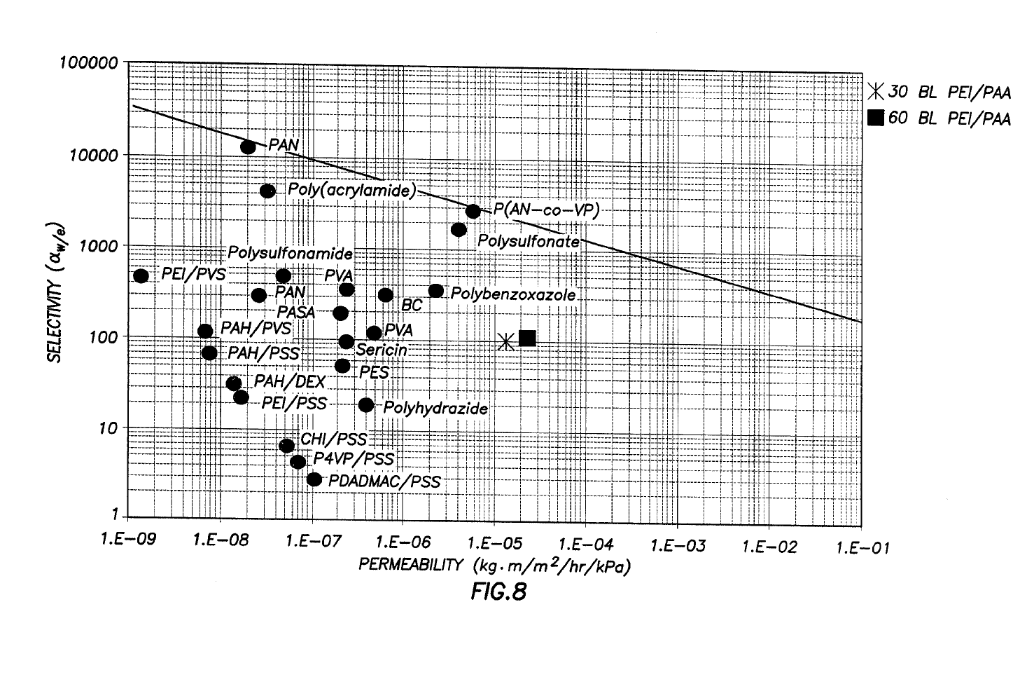

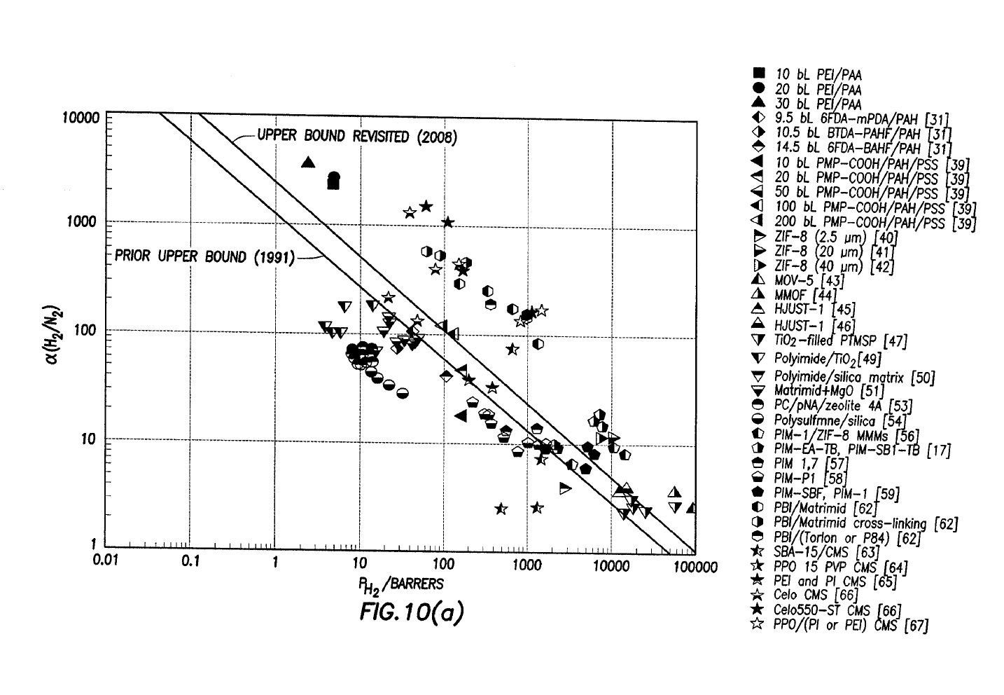

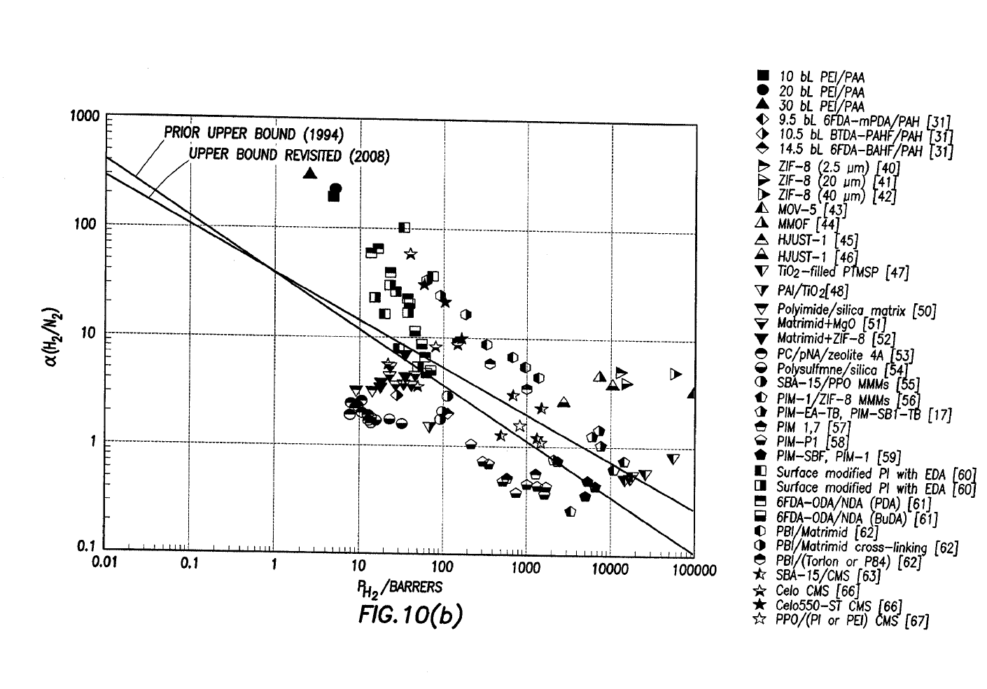

FIG. 7(a) shows average elastic modulus, FIG. 7(b) shows hardness of 10 bilayer PEI/PAA films under different environmental conditions (error bars represent standard deviation), and FIG. 7(c) shows FTIR spectra of 10 bilayer PEI/PAA film. Gas permeation testing was performed by MOCON (Minneapolis, Minn.) in accordance with ASTM D-3985, using Oxtran 2/21 ML for oxygen, Permatran-C 4/41 ML for carbon dioxide and Multi-Tran 400 ML for hydrogen, helium and methane at 23° C. and 0% RH. A Hysitron TI 950 Tribolndenter TM was used to measure mechanical properties of 10 bilayer PEI/PAA film. The modulus and the hardness of the sample were measured in two different environments: 38° C. with 50% relative humidity (RH) and 25° C. with 22% RH. FTIR spectra of LbL films were measured with a Bruker Optics ALPHA-P 10098-4 spectrometer in ATR mode. PAA peaks in its covalent (COOH) and ionic form (COO⁻) were used to compare the ionic interaction between polycation and polyanion, or so called ‘degree of ionization’. FIG. 8 illustrates selectivity and permeability for water/ethanol with 30 bilayers PEI/PAA and 60 bilayers in comparison to other non layer-by-layer pervaporation membranes. FIG. 10(a) shows Robeson's upper bound plot from 1991 for H₂/N₂. FIG. 10(b) shows Robeson's upper bound plot from 1994 for H₂/CO₂. Table I compares results of the comparison. In FIGS. 10(a), 10(b), 10, 20, and 30 bilayers of PEI/PAA separation film are compared to various other polymers, inorganics, and mixed matrix membranes.

TABLE I

| | | | | | | Permeability |
|---|---|---|---|---|---|---|
| | X_{H20,} | T | Flux | | Thick. | kg · m/m²/hr/ |
| Pervaporation Membranes | wt % | ° C. | kg/m²/h | α_{w/e} | μm | kPa |
| Polysulfonate | 0.3 | 84 | 0.006 | 1630 | 30 | 4.07E−06 |
| Polysulfonamide | 4 | 84 | 0.016 | 450 | 30 | 5.03E−08 |
| Sericin | 10 | 60 | 0.07 | 90 | 24.2 | 2.33E−07 |
| Polyvinyl alcohol (PVA) | 10 | 60 | 0.12 | 115 | 29.3 | 4.83E−07 |
| Polyacrylonitrile (PAN) | 8 | 50 | 0.007 | 281 | 15.5 | 2.61E−08 |
| Poly(acrylonitrile) | 30 | 70 | 0.007 | 12500 | 50 | 2.11E−08 |
| Poly(acrylamide) | 30 | 70 | 0.011 | 4080 | 50 | 3.31E−08 |
| Poly(vinyl alcohol) (PVA) | 30 | 70 | 0.08 | 350 | 50 | 2.41E−07 |
| Poly(ether sulphone) | 30 | 70 | 0.072 | 52 | 50 | 2.17E−07 |
| Polyhydrazide | 30 | 70 | 0.132 | 19 | 50 | 3.98E−07 |
| Bacterial cellulose (BC) | 30 | 30 | 0.112 | 287 | 100 | 6.28E−07 |
| Poly(amidesulfonamide) (PASA) | 10 | 20 | 0.0045 | 191.2 | 30 | 2.12E−07 |
| Poly(acrylonitrile-co-vinyl pyridine) P(AN-co- | 10 | 20 | 0.3582 | 2591 | 10 | 5.63E−06 |
| VP) | | | | | | |
| polybenzoxazole | 15 | 25 | 0.082 | 331 | 23 | 2.22E−06 |
| Polyethyleneimine/polyvinylsulfate (PEI/PVS) | 6.2 | 58.5 | 0.045 | 443.3 | 0.06 | 1.40E−09 |
| Polyallylammonium/PVS (PAH/PVS) | 6.2 | 58.5 | 0.220 | 109.9 | 0.06 | 6.86E−09 |
| PAH/dextrane sulfate (PAH/DEX) | 6.2 | 58.5 | 0.450 | 31.14 | 0.06 | 1.40E−08 |
| EI/PSS(Poly(styrenesulfonate sodium salt) | 6.2 | 58.5 | 0.540 | 21.86 | 0.06 | 1.68E−08 |
| Polyallylammonium/PSS (PAH/PSS) | 6.2 | 58.5 | 0.240 | 64.08 | 0.06 | 7.48E−09 |
| Chitosan/PSS (CHI/PSS) | 6.2 | 58.5 | 1.740 | 6.39 | 0.06 | 5.42E−08 |
| Poly(4-vinylpyridine)(P4VP)/PSS | 6.2 | 58.5 | 2.330 | 4.42 | 0.06 | 7.26E−08 |
| Poly(diallydimethylammonium | 6.2 | 58.5 | 3.410 | 2.75 | 0.06 | 1.06E−07 |
| chloride)(PDADMAC)/PSS | | | | | | |
| PEI/PAA (30 LbL) | 10 | 25 | 1.637 | 97.9 | 5 | 1.29E−05 |
| PEI/PAA (60 LbL) | 10 | 25 | 1.432 | 104.7 | 10 | 2.25E−05 |

### Example 2

### Materials

Branched polyethylenimine (PEI) (Aldrich, St. Louis, Mo.) (M W=25,000 mol⁻¹) was dissolved in deionized (DI) water (18.2 MΩ) to create a 0.1 wt % solution. The pH of the PEI solution was reduced to 10 by adding hydrochloric acid (HCl) (1.0 M). Single layer grapheneoxide (GO) (CheapTubes, Brattleboro, Vt.) was exfoliated in DI water by ultrasonication (10 W) for 10 min with a MISONIX XL-2000 tip sonicator (Qsonica, Melville, N.Y.). Anionic GO suspensions (0.01, 0.05, and 0.2 wt %) were prepared by sonicating 100 mL volumes. In order to prevent GO depletion, suspensions were replaced after every 10 bilayers of deposition.

Substrates:

Single-side-polished (100) silicon wafers (University Wafer, South Boston, Mass.) were used to measure thickness growth and surface topography. Wafers were piranha treated with a 3:7 ratio of hydrogen peroxide (30%) to sulfuric acid (99%), and stored in deionized water, before being used. Just prior to LbL deposition, the silicon wafers were rinsed with acetone and deionized water. Polished Ti/Au crystals with a resonance frequency of 5 MHz were purchased from Maxtek, Inc (Cypress, Calif.) and used as deposition substrates for quartz crystal microbalance (QCM) measurements. Poly(ethylene terephthalate) (PET) film, with a thickness of 179 m (trade name: ST505, Dupont-Teijin), was purchased from Tekra (New Berlin, Wis.) for barrier measurements. A 175-μm polystyrene (PS) film (Goodfellow, Oakdale, Pa.) was used as a substrate for transmission electron microscopy (TEM). PS and PET films were cleaned with DI water and methanol and then corona-treated with a BD-20C Corona Treater (Electro-Technic Products Inc., Chicago, Ill.) before LbL deposition. Corona treatment improved adhesion of the first layer by oxidizing the film surface.

LbL Deposition:

A given substrate was dipped into a positively-charged PEI solution for 5 min, then rinsed with deionized water for 30 s and dried with a stream of filtered air, followed by the same procedure with a negatively-charged GO solution. One deposition cycle of oppositely charged mixtures creates one bilayer (BL). Starting from the second BL, one-minute dips in both PEI and GO were used. The process was stopped when the desired number of BL was achieved, which was controlled by a home-built robot system.

Characterization:

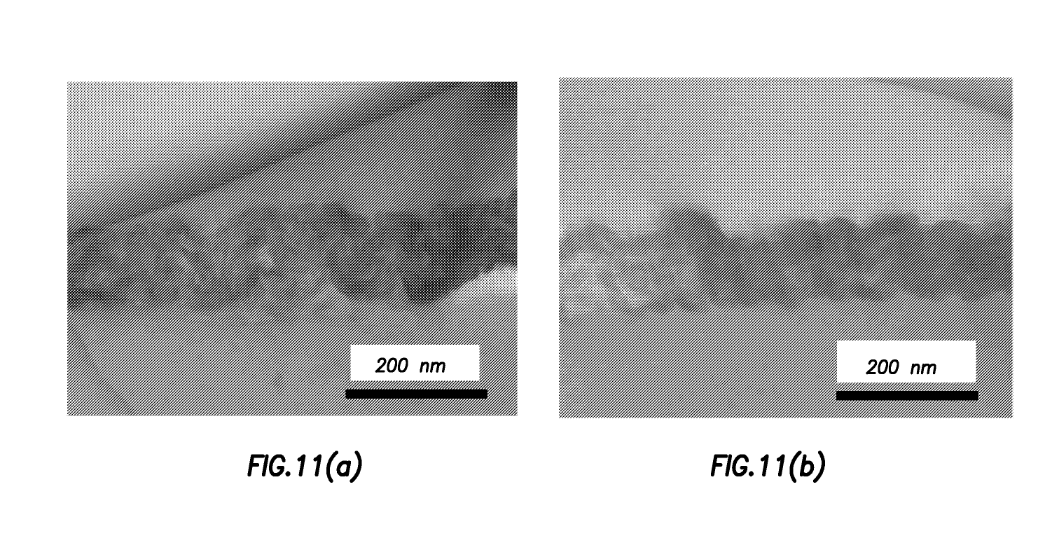

Film thickness on silicon wafers was measured with an alpha-SE Ellipsometer (J. A. Woollam Co., Inc., Lincoln, Nebr.). Mass of each layer was measured with a Research quartz crystal microbalance (QCM) (Inficon, East Syracuse, N.Y.), using a frequency range of 3.8-6 MHz. The 5 MHz quartz crystal was inserted in a PVDF holder and dipped into the PEI and GO mixtures. After each deposition, the crystal was rinsed and dried and then left on the microbalance to stabilize for five minutes. Cross-sections of the PEI/GO assemblies were imaged with a JEOL 1200 EX (Parbody, Mass.) TEM, operated at 100 kV. Samples were prepared for imaging by embedding a piece of PS, supporting the LbL film, in epoxy prior to sectioning with a microtome. Surface morphology of the coated silicon wafers were imaged with a multimode scanning probe microscope (AFM) (Veeco Digital Instruments, Santa Barbara, Calif.) operated in tapping mode. FIGS. 11(a), (b) show TEM cross-sectional images. Oxygen transmission rate (OTR) testing was performed in accordance with ASTM D-3985, using an Oxtran 2/21 ML instrument at 23° C. and 0% (or 100%) RH. Hydrogen transmission rate (H₂ TR) testing was performed using a MOCON Multi-Tran 400 instrument, utilizing a TCD sensor. Carbon dioxide transmission rate (CO₂ TR) testing was performed in accordance with ASTM F-2476, using a MOCON Permatran C 4/41 instrument. All gas transmission rate tests were performed at MOCON (Minneapolis, Minn.). Table II illustrates oxygen permeability of PEI/GO multilayer assemblies on PET.

TABLE II

| | | | Permea- | Permea- | Permea- |
|---|---|---|---|---|---|
| | | | bility | bility | bility |
| | | | [10⁻¹⁶ | [10⁻¹⁶ | [10⁻¹⁶ |
| | OTR | Assembly | cm³ cm | cm³ cm | cm³ cm |
| | cc m⁻² | Thick- | cm⁻² s⁻¹ | cm⁻² s⁻¹ | cm⁻² s⁻¹ |
| | day⁻¹ | ness | Pa⁻¹ ] | Pa⁻¹] | Pa⁻¹] |
| Recipe | atm⁻¹ | 100% RH | Nm | Assembly | Total |
| 179-μ | 8.48 | 6.60 | N/A | N/A | 17.3 |
| (PEI/GO_{0.01})₁₀ | 1.28 | N/A | 42 | 0.0014 | 2.62 |
| (PEI/GO_{0.01})₂₀ | 0.43 | N/A | 84 | 0.00087 | 0.88 |
| (PEI/GO_{0.01})₃₀ | 0.27 | N/A | 128 | 0.00082 | 0.55 |
| (PEI/GO_{0.05})₁₀ | 0.77 | 1.20 | 50 | 0.00097 | 1.58 |
| (PEI/GO_{0.05})₂₀ | 0.31 | 0.57 | 98 | 0.00072 | 0.63 |
| (PEI/MMT_{0.05})₂₀ | 6.12 | N/A | 52 | 0.0256 | 12.52 |
| (PEI/GO_{0.05})₃₀ | 0.19 | 0.36 | 149 | 0.00066 | 0.39 |
| (PEI/GO_{0.2})₁₀ | 0.12 | N/A | 91 | 0.00025 | 0.25 |
| (PEI/MMT_{0.2})₁₀ | 5.60 | N/A | 28 | 0.0104 | 11.45 |

### Example 3

Film growth and structure of assemblies made with cationic polyethylenimine (PEI) and anionic montmorillonite clay (MMT) and poly(acrylic acid) (PAA), where one deposition sequence of PEI/PAA/PEI/MMT is referred to as a quadlayer (QL), was shown schematically in FIG. 5. The exponential growth observed in the ellipsometric data was believed to be caused by interdiffusion of the weak polyelectrolytes (PEI and PAA) during deposition. This system had a thickness of approximately 174 nm after only six quadlayers were deposited onto silicon. Quartz crystal microbalance data confirm both the exponential growth trend observed with ellipsometry and uniform clay deposition, with all clay layers containing approximately the same mass per layer. A five QL film contains 26.2 wt. % clay (Table III), which were nearly an order of magnitude greater than most conventional bulk composites. Furthermore, QCM confirmed the clay concentration decreased with the number of QLs deposited, which was expected because it was the polyelectrolyte pairs that were contributing to the exponential growth, rather than the clay (see Table III).

TABLE III

| | | | Permeability | Permeability |
|---|---|---|---|---|
| | Clay | | (10⁻¹⁶ cm³ | (10⁻¹⁶ cm³ |
| Thin | con- | Film | (STP) · cm/ | (STP) · cm/ |
| film | centration | thickness | (cm² · s · Pa)) | (cm² · s · Pa)) |
| assembly | (wt. %) | (nm) | Film | Total |
| (PEI/PAA) | 0 | 48.7 | 0.227 | 16.80 |
| 2 QL | 53.7 | 16.1 | 0.066 | 16.70 |
| 3 QL | 48.6 | 28.3 | 0.002 | 4.79 |
| 4 QL | 36.7 | 50.9 | ≦0.000005 | ≦0.001 |
| 5 QL | 26.2 | 82.6 | ≦0.000009 | <0.001 |

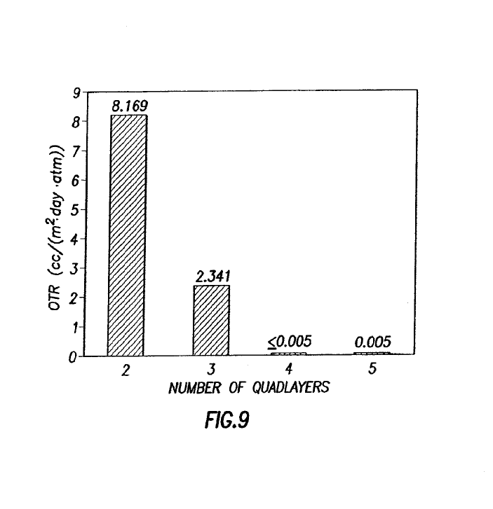

During LbL deposition, the negatively charged surface of MMT was electrostatically attracted to the positively charged film surface created by PEI, allowing for only those clay platelets oriented with their largest dimension parallel to the surface to adsorb. In addition to producing low oxygen permeability, this high level of orientation and clay platelet separation also provided the high optical clarity seen in these thin films. The oxygen transmission rate (OTR) of these films decreased rapidly with the number of quadlayers deposited on 179 μm poly(ethylene terephthalate) (PET) film, as shown in FIG. 9. It was striking to see this significant decrease in OTR within the first few QLs deposited. A four QL film exhibited an OTR equal to or below the detection limit of commercial instrumentation (e^{0.005} cm³/(m²·day·atm)). This high barrier performance with only four clay layers (or 16 total layers) was unprecedented for a polymer nanocomposite, especially one that was only 51 nm thick. When the coating permeability was decoupled from the total permeability, this thin film was shown to exhibit the lowest oxygen permeability ever reported for a polymer-clay material (e⁵×10⁻²² cm³(STP)·cm/(cm²·s·Pa)) (Table III), which was at least 2 orders of magnitude below that reported for completely inorganic SiOx barrier thin films and 4 orders of magnitude lower than a 25 μm EVOH copolymer film. A film containing only the polymer layers at an identical thickness to the 4 QL film was also tested for OTR to investigate their contribution to the barrier. As shown in Table III, approximately 50 nm of PEI/PAA (3.5 bilayers) have a permeability of 0.227×10-16 cm³(STP)·cm/(cm²·s·Pa)), approximately 45,000 times larger than that of four clay containing quadlayers. The ability to produce such a low permeability film from water with a relatively small number of layers should make this a relatively low-cost, commercially viable system for various packaging applications. This incredible barrier performance was believed to be due to the highly aligned clay nanostructure within the film and relatively large clay layer spacing that was achieved with this exponentially growing recipe. Expanding the space between deposited clay layers, by depositing thicker polymer layers, was the key to enhancing the barrier of these films. The exponentially increasing growth created thicker polymer between platelet layers to further increase the residence time of permeating molecules that “wiggle” perpendicular to the diffusion direction. This caused the molecule to travel a longer diffusion length through the channels between clay layers (i.e., perpendicular to the film thickness), thus lowering the permeability of the coating and increasing its barrier performance. The oxygen transmission rates shown in FIG. 9 were measured under dry conditions (0% relative humidity (RH)), but LbL thin film properties were expected to degrade at higher humidity. Thermal cross-linking of LbL films was a viable way to reduce moisture sensitivity. The primary amines of PEI and carboxylic acid groups of PAA were ideal for cross-linking at relatively low temperatures. Seven QL films were tested at high humidity with and without thermal cross-linking at 80 OC for 2 h. Both films were first tested at 0% RH to reveal undetectable OTRs (<0.005 cm³/(m²·day·atm)), before being tested at 100% RH. The heated film's humid OTR (0.093 cm³/(m²·day·atm)) was 33% lower than that of the unheated film's and 2 orders of magnitude lower than that of the bare PET substrate under dry conditions. This level of barrier at such high humidity was among the best reported for clay-polymer composites created by other means, whose films are typically 1,000 times thicker, less transparent, and also suffered from moisture sensitivity. Although this level of barrier was likely insufficient for flexible electronics, the experiment demonstrated that cross-linking may reduce moisture sensitivity. This post assembly film treatment highlighted the ease with which these films may be enhanced, and better cross-linking may further improve barrier under high humidity. In addition, it was already known that laminating a film of high moisture barrier to the surface of an LbL oxygen barrier may provide an undetectable OTR at 100% RH. Assemblies may also be deposited directly onto a film with very low moisture vapor transmission rate (e.g., poly(chlorotrifluoroethylene)) rather than the PET used in this work.

Table IV shows gas transmission through a 4 QL assembly.

TABLE IV

| | Gas Transmission Rate | Gas Transmission Rate |
|---|---|---|
| | (cc/m² · day) | (cc/m² · day) |
| Gas | 7-mil PET | 4 QL on PET |
| O₂ | 8.6 | <0.005 |
| CO₂ | 36 | <1 |
| H₂ | 286 | 27 |

Although the present disclosure and its advantages have been described in detail, it should be understood that various changes, substitutions and alterations may be made herein without departing from the spirit and scope of the disclosure as defined by the appended claims.

What is claimed is:

1. A method for coating a substrate to provide a separation substrate, comprising:
(A) exposing the substrate to a cationic solution to produce a cationic layer deposited on the substrate, wherein the cationic solution comprises cationic materials, and wherein the cationic materials comprise a polymer, a colloidal particle, a nanoparticle, a nitrogen-rich molecule, or any combinations thereof; and
(B) exposing the cationic layer to an anionic solution to produce an anionic layer deposited on the cationic layer to produce a layer comprising the anionic layer and the cationic layer, wherein the anionic solution comprises a layerable material.

2. The method of claim 1, wherein the layerable material comprises an anionic polymer, a colloidal particle, a phosphated molecule, a sulfated molecule, a boronic acid, a boron containing acid, or any combinations thereof.

3. The method of claim 1, wherein the substrate comprises a primer layer.

4. The method of claim 1, further comprising exposing the anionic layer to a second cationic solution to produce a second cationic layer deposited on the anionic layer.

5. The method of claim 4, further comprising exposing the second cationic layer to a second anionic solution to produce a second anionic layer on the second cationic layer.

6. The method of claim 1, wherein the polymer comprises a cationic polymer, and wherein the cationic polymer comprises branched polyethylenimine, polyethylenimine, cationic polyacrylamide, cationic poly diallyldimethylammonium chloride, poly (melamine-co-formaldehyde), polymelamine, copolymers of polymelamine, polyvinylpyridine, copolymers of polyvinylpyridine, poly(allyl amine), poly(allyl amine) hydrochloride, poly(vinyl amine), poly(acrylamide-co-diallyldimethylammonium chloride), or any combinations thereof.

7. The method of claim 1, wherein the polymer comprises a polymer with hydrogen bonding, and wherein the polymer with hydrogen bonding comprises polyethylene oxide, polyallylamine, polyglycidol, polypropylene oxide, poly(vinyl methyl ether), polyvinyl alcohol, polyvinylpyrrolidone, branched polyethylenimine, linear polyethylenimine, poly(acrylic acid), poly(methacrylic acid), copolymers thereof, or any combinations thereof.

8. The method of claim 1, wherein the substrate comprises a porous organic material, an inorganic material, a polymeric material, or any combinations thereof.

9. The method of claim 1, further comprising a crosslinker.

10. The method of claim 9, wherein the crosslinker comprises a bromoalkane, an aldehyde, a carbodiimide, an amine active ester, an epoxide, uridine, a diol, epichlorohydrin, aziridine, or any combinations thereof.

11. A method for coating a substrate to provide a separation substrate, comprising:
(A) exposing the substrate to an anionic solution to produce an anionic layer deposited on the substrate, wherein the anionic solution comprises a layerable material; and
(B) exposing the anionic layer to a cationic solution to produce a cationic layer deposited on the anionic layer to produce a layer comprising the anionic layer and the cationic layer, wherein the cationic solution comprises cationic materials, and wherein the cationic materials comprise a polymer, a colloidal particle, a nanoparticle, a nitrogen-rich molecule, or any combinations thereof.

12. The method of claim 11, wherein the layerable material comprises an anionic polymer, a colloidal particle, a phosphated molecule, a sulfated molecule, a boronic acid, a boron containing acid, or any combinations thereof.

13. The method of claim 11, wherein the substrate comprises a primer layer.

14. The method of claim 11, further comprising exposing the cationic layer to a second anionic solution to produce a second anionic layer deposited on the cationic layer.

15. The method of claim 14, further comprising exposing the second anionic layer to a second cationic solution to produce a second cationic layer on the second anionic layer.

16. The method of claim 11, wherein the polymer comprises a cationic polymer, and wherein the cationic polymer comprises branched polyethylenimine, polyethylenimine, cationic polyacrylamide, cationic poly diallyldimethylammonium chloride, poly (melamine-co-formaldehyde), polymelamine, copolymers of polymelamine, polyvinylpyridine, copolymers of polyvinylpyridine, poly(allyl amine), poly(allyl amine) hydrochloride, poly(vinyl amine), poly(acrylamide-co-diallyldimethylammonium chloride), or any combinations thereof.

17. The method of claim 11, wherein the polymer comprises a polymer with hydrogen bonding, and wherein the polymer with hydrogen bonding comprises polyethylene oxide, polyallylamine, polyglycidol, polypropylene oxide, poly(vinyl methyl ether), polyvinyl alcohol, polyvinylpyrrolidone, branched polyethylenimine, linear polyethylenimine, poly(acrylic acid), poly(methacrylic acid), copolymers thereof, or any combinations thereof.

18. The method of claim 11, wherein the substrate comprises a porous organic material, an inorganic material, a polymeric material, or any combinations thereof.

19. The method of claim 11, further comprising a crosslinker.

20. The method of claim 19, wherein the crosslinker comprises a bromoalkane, an aldehyde, a carbodiimide, an amine active ester, an epoxide, uridine, a diol, epichlorohydrin, aziridine, or any combinations thereof.
